(19) United States
(12) Patent Application Publication
(10) Pub. No.: US 2024/0044057 A1
(43) Pub. Date: Feb. 8, 2024

(54) METHOD FOR MANUFACTURING A KNITTED FABRIC REPRODUCING AN ADVERSARIAL IMAGE

(71) Applicant: POLITECNICO DI MILANO, Milano (IT)

(72) Inventors: Giovanni Maria CONTI, Milano (IT); Rachele DIDERO, Milano (IT)

(73) Assignee: POLITECNICO DI MILANO, Milano (IT)

(21) Appl. No.: 18/264,467

(22) PCT Filed: Feb. 7, 2022
(86) PCT No.: PCT/IB2022/051036

§ 371 Date: Aug. 7, 2023

(30) Foreign Application Priority Data
Feb. 8, 2021 (IT) 102021000002729

(51) Int. Cl. D04B 37/00; D04B 1/12; D04B 21/08; D04B 15/84; G06T 3/40; G06T 7/90

(52) U.S. Cl. CPC D04B 37/00; D04B 1/126; D04B 21/08; D04B 15/84; G06T 3/40; G06T 7/90; G06T 2207/10024; G06T 2207/30124

(57) ABSTRACT

A method for manufacturing a jacquard knitted fabric, including providing an electronic unit for processing digital images; providing a programmable Y-yarn Jacquard knitting machine; obtaining a known digital adversarial image; reducing the image so that the proportions are maintained, the maximum size is reduced to P pixels (P≤750) and the minimum size is reduced to p pixels (p≥100); halving the height of the image and maintaining the width; posterizing the adversarial image by reducing the colors to C (4≤C≤Y); generating the operation instructions for the machine, where each color in the image corresponds to a respective yarn and each pixel in the image corresponds to a stitch; selecting C yarns to approximate the colors of the posterized image; feeding the C yarns to the machine; and operating the machine for manufacturing a knitted fabric reproducing the image.

### TECHNICAL FIELD

The present invention refers to the Jacquard knitwear sector, in particular the invention refers to a method for obtaining a knitted fabric reproducing an adversarial image.

### BACKGROUND

As is well known, recent years have seen a considerable development in computer vision techniques, meaning thereby those techniques that aim to reproduce the capabilities of human sight, not only as a simple acquisition of a two-dimensional image, but above all as the ability to interpret the content of the image itself.

An artificial vision system consists of the integration of optical, electronic, mechanical and software components that allow for the acquisition, recording and processing of images. Generally, the result of the processing is the recognition of certain characteristics of the image for various purposes of control, classification, selection, etc.

One of the most interesting uses of computer vision is the detection of objects and people by specific artificial intelligence algorithms. The ability to automatically detect the presence of a specific object or person in an image is of great importance in various fields, such as diagnostic imaging, self-driving of vehicles and searching for images in huge digital archives. Nowadays, thanks to deep learning techniques, algorithms are available that can perform these recognition functions very reliably and very quickly, e.g. in real time or even faster. Among these algorithms, one of the most widely used commercially is called YOLO (You Only Look Once), available in various versions.

Although the results described above provide excellent prerequisites for many undoubtedly useful uses, some observers also note that they pose a potential threat to the privacy of the population at the same time. The video surveillance systems set up in public places or, even more so, in private places open to the public, can potentially proceed in complete autonomy to the recognition and therefore to the tracking of people without their knowledge and without having granted any permission.

A proposed solution for this type of problem is based on so-called adversarial images, which have been developed with the intention of fooling the most advanced automatic detection systems. Some adversarial images are generated by superimposing a natural image with targeted disturbances that are substantially invisible to the human eye but completely alter the perception of automatic detection systems. This technique, which is useful for protecting already acquired and stored images from recognition, is not applicable in the physical mode for real-time protection, e.g. in transit within an area covered by a video surveillance system. For this type of application, a different technique was developed, based on adversarial images to be physically placed close to the face of the person exposed to the machine vision system. In this case too, the adversarial image, appearing in the visual field of the recognition system, is able to mislead the algorithm and not allow the user to be recognised as a person. The misleadingness induced by adversarial images can have different effects on the recognition algorithm. In some cases, the effect may be to make the algorithm recognise the presence of a fictitious object or animal that is not really present, in other cases to make it recognise the presence of fictitious people (non-existent people and in any case not coinciding with the user of the adversarial image), and in other cases, finally, the effect may be not to detect anything. In any case, regardless of the specific effect it achieves, the adversarial image protects the user from unwanted recognition.

Adversarial images, known per se, are complex images, characterised by high definition and a large number of colors. Today, due to their complexity, these images can only be printed, a technique which implies some important limitations from the point of view of use in the textile sector and the manufacture of clothing.

The need is therefore felt to be able to create adversarial images by means of different techniques, more versatile from the point of view of use in the textile sector and the manufacture of clothing.

### SUMMARY

An object of the present invention is to overcome the drawbacks of the prior art.

In particular, a task of the present invention is to make available a method for manufacturing a knitted fabric reproducing an effective adversarial image, i.e., an adversarial image that is capable of misleading human recognition algorithms.

These and other purposes and tasks of the present invention are achieved by means of a method for manufacturing a Jacquard knitted fabric incorporating the features of the appended claims, which form an integral part of the present description.

The invention relates to a method for manufacturing a jacquard knitted fabric. The method of the invention comprises the steps of:
Providing an electronic processing unit configured for modifying digital images;
Providing a programmable electronic Jacquard knitting machine, configured for managing Y yarns, including the waste yarn;
Obtaining a known digital adversarial image having more than 256 colors;
Modifying the size of the adversarial image such that:
   the original proportions are maintained
   the maximum size between height and width is set to P pixels, with P≤750;
   the minimum size between height and width is set to p pixels, with p≥100;
Modifying the size of the adversarial image such that:
   the number of pixels of the height is halved with respect to the previous step;
   the number of pixels of the width is maintained the same with respect to the previous step;
Posterizing the adversarial image reducing the number of colors to C, where 4≤C≤Y;
Generating the operation instructions for the programmable electronic Jacquard knitting machine, wherein:
   each color of the adversarial image corresponds to a respective yarn; and
   each pixel of the adversarial image corresponds to one stitch visible on the front of the knitted fabric;
Selecting C yarns having each one a different prevalent color, such that the prevalent colors of the yarns best approximate the colors of the posterized adversarial image;
Feeding the C yarns to the Jacquard knitting machine; and
Operating the Jacquard knitting machine for manufacturing a knitted fabric reproducing the adversarial image.

Advantageously, the characteristics defined in the method in accordance with the invention for the adversarial image enable it to retain its effectiveness even when reproduced on a jacquard knitted fabric.

Preferably, if the programmable electronic Jacquard knitting defines gauge 24, then p≥100 and P≤750.

Preferably, if the programmable electronic Jacquard knitting machine defines gauge 12, then p≥180 and P≤375.

Furthermore, if the programmable electronic Jacquard knitting machine defines gauge 12, preferably the adversarial image has:
minimum size of at least 100 stitches, if at least 8 colors are used (p≥100 if C≥8);
minimum size of at least 200 stitches, if at least 7 colors are used (p≥200 if C≥7); or
minimum size of at least 250 stitches, if at least 4 colors are used (p≥250 if C≥4).

In accordance with an embodiment of the method, one or more of the C yarns is made of a plurality of different threads.

Preferably at least one of the target colors defined during the posterization step is approximated by the average of all the colors of the threads in a yarn.

Preferably, for the back side of the knitted fabric a twill structure is adopted.

Preferably, the yarns are cotton, polyester, viscose, rayon, acetate, bemberg, lurex and/or silk yarns.

Further features and advantages of the present invention will be more evident from the description of the accompanying drawings.

### BRIEF DESCRIPTION OF THE DRAWINGS

The invention will be described hereinafter with reference to some examples, given by way of non-limiting example, and illustrated in the appended drawings.

FIG. 1 represents a flow diagram of the method in accordance with the invention.

### DETAILED DESCRIPTION OF THE EMBODIMENTS

While the invention is susceptible to various modifications and alternative constructions, certain preferred embodiments are shown in the drawings and are described hereinbelow in detail. It must in any case be understood that there is no intention to limit the invention to the specific embodiment illustrated, but, on the contrary, the invention intends covering all the modifications, alternative and equivalent constructions that fall within the scope of the invention as defined in the claims.

The use of “for example”, “etc.”, “or” indicates non-exclusive alternatives without limitation, unless otherwise indicated. The use of “comprises” and “includes” means “comprises or includes, but not limited to”, unless otherwise indicated.

The invention relates to a method for manufacturing a jacquard knitted fabric. The method of the invention comprises the steps of:
Providing an electronic processing unit configured for modifying digital images;
Providing a programmable electronic Jacquard knitting machine, configured for managing Y yarns, including the waste yarn;
Obtaining a known digital adversarial image having more than 256 colors;
Modifying the size of the adversarial image such that:
   the original proportions are maintained;
   the maximum size between height and width is set to P pixels, with P≤750;
   the minimum size between height and width is set to p pixels, with p≥100;
Modifying the size of the adversarial image such that:
   the number of pixels of the height is halved with respect to the previous step;
   the number of pixels of the width is maintained the same with respect to the previous step;
Posterizing the adversarial image reducing the number of colors to C, where 4≤C≤Y;
Generating the operation instructions for the programmable electronic Jacquard knitting machine, wherein:
   each color of the adversarial image corresponds to a respective yarn; and
   each pixel of the adversarial image corresponds to one stitch visible on the front of the knitted fabric;
Selecting C yarns having each one a different prevalent color, such that the prevalent colors of the yarns best approximate the colors of the posterized adversarial image;
Feeding the C yarns to the Jacquard knitting machine; and
Operating the Jacquard knitting machine for manufacturing a knitted fabric reproducing the adversarial image.

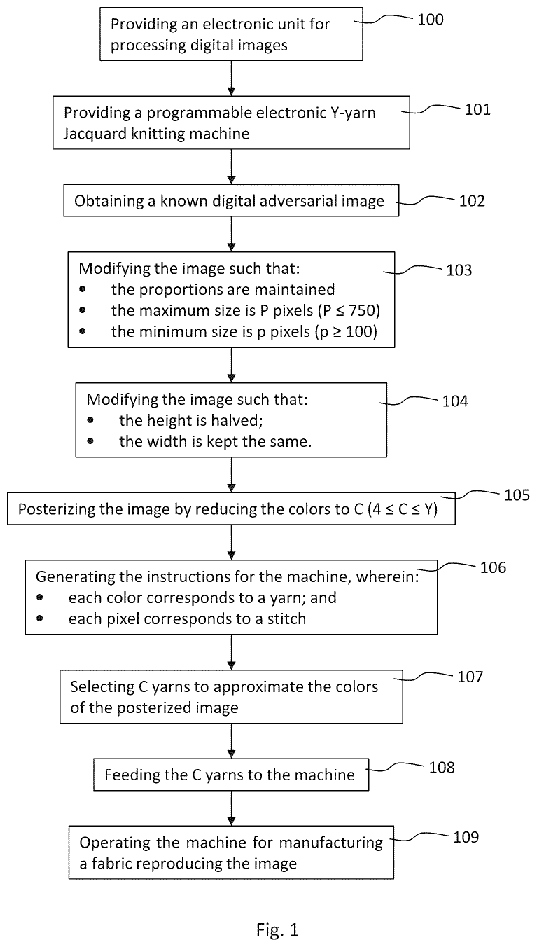

As the skilled person can well understand, in block 100 of FIG. 1, the electronic processing unit is preferably a computer, the hardware and software characteristics of which make it suitable for processing images in digital form. In particular, it is preferable that the computer comprises specialised software for processing and editing digital images. A suitable software for this purpose is, for example, Adobe Photoshop developed and distributed by Adobe Incorporated.

In the field of knitwear, the technique known as Jacquard is known, named after the loom invented by Joseph Marie Jacquard in 1804. Similarly to the loom bearing the same name, Jacquard knitting machines are configured to manufacture knitted fabrics reproducing a predefined graphic solution (or pattern) on the front. For this purpose, Jacquard knitting machines are configured to manage a plurality of yarns, usually of different colors, and are able to operate following specific instructions that define, for each single stitch visible on the front of the fabric, which yarn to use among those available.

In the field of Jacquard knitting machines, programmable or computerized electronic machines are also known (block 101), in which the instructions are prepared in digital form, similar to what happens in a common printer. In the following, unless otherwise specified, the expressions “machine” and “knitting machine” are used, for the sake of brevity, to refer more particularly to a “programmable electronic Jacquard knitting machine”.

The programmable electronic Jacquard knitting machines are configured to process a provided pattern in digital form. In particular, this machine is configured to convert the source pattern into its own work pattern in which each color of the source pattern corresponds to a respective yarn and each pixel of the source pattern corresponds to a visible stitch on the front of the fabric. The work pattern provides the operator with feedback on the operations of the machine. In addition, the machine is able to generate its own work file containing the instructions for the correct operation of the machine's electromechanical parts (e.g. needles) to reproduce the work pattern in the knitted fabric.

As already mentioned above, each machine is configured to manage a maximum number of yarns, which is indicated herein by Y. These Y yarns usually comprise Y−1 working yarns and 1 yarn called waste yarn. The working yarns are usually of different colors and make up the palette of colors available to recreate the pattern. The working yarns are those that make up the actual knitted fabric. The waste yarn, on the other hand, is used to produce the initial section of the knitted fabric which, once dismounted from the machine, must be removed from the finished product. Hereinafter Y comprises both the working yarns and the waste yarn.

In the most common electronic programmable Jacquard knitting machines Y is equal to 8. There are also machines in which Y takes on higher values, for example 32. However, it must be considered that in Jacquard knitted fabric all the yarns used by the machine are always present, even those that do not appear in any stitch on the front. This leads to an increase in the thickness of the fabric itself as the number of yarns used increases. Consequently, too many colors and therefore too many yarns would result in a fabric that is uncomfortable or even impossible to use in a piece of clothing. In this regard, it should also be considered that the thickness of the Jacquard knitted fabric depends not only on the number of yarns used but also on their count. Therefore, within certain limits, it is possible to obtain fabrics of acceptable thickness by increasing the number of yarns and at the same time decreasing their count.

In view of all of the above, it is difficult to define the maximum number of yarns that may be used in the method in accordance with the invention. By way of example, the maximum number of yarns used simultaneously can be set to 18, while in the specific examples considered below it is equal to 8.

Knitting machines comprise Y yarn guides (for example 8 yarn guides), where each yarn guide carries a specific yarn from the respective spool to the machine members. In the machine's operation instructions, each yarn guide is associated with a specific color.

The yarns used may consist of one or more threads, e.g. three threads, each of which may have different characteristics to meet specific needs. Of course, the size of each yarn (usually expressed as a count) must be within the machine's specifications, regardless of whether the yarn consists of a single thread or a plurality of threads. In the latter case, the sum of the thread counts must be adapted to the machine's specifications.

Programmable electronic Jacquard knitting machines which are suitable for use in the method of the invention (block 101) are, for example, the STOLL CMS 330 marketed by KARL MAYER STOLL Textilmaschinenfabrik GmbH and the SHIMA SEIKI computerized knitting machine marketed by SHIMA SEIKI MFG., LTD.

Both of these machines can have gauge 12, which means there are 12 needles on the needle bed of the machine in each inch (2.54 cm). Although this is the most common gauge among commercial machines, there are also machines with higher gauge that are equally suitable for use in the method of the invention. On the contrary, machines with lower gauge (e.g. gauge 7) are problematic and can only be used only in some embodiments of the method of the invention.

This method is not aimed at manufacturing an adversarial image from scratch, but only at reproducing it by Jacquard knitting. For this reason, the method includes the step of digitally obtaining an already known adversarial image (block 102). This means that the effectiveness of the image on the automatic recognition algorithms has already been tested a priori and that the image can therefore be considered an adversarial image to all intents and purposes. In other words, the abilities to mislead recognition algorithms are already inherent in the image, its constituent shapes and colors. The present method merely aims to reproduce a form of such an adversarial image that, although simplified, still retains such ability to mislead automatic recognition algorithms. In particular, the method aims to reproduce an adversarial image that is effective in avoiding recognizing people, despite the fact that they present a high level of intra-class variety.

In the field of Jacquard knitting, the minimum unit of the images that can be obtained is the stitch, which therefore performs the function of the pixel in digital images. However, the conversion between pixels and stitches cannot be established directly because the number of pixels in an adversarial image is usually too large for the size of the machine and would in any case result in an image that is too large to be used easily. The ultimate purpose of the adversarial image requires that it be visible in its entirety when the knitted fabric reproducing it is correctly used by a user. If the adversarial image obtained were too large, the knitted fabric reproducing it would have to be folded or wrapped by the user, with the effect of only partially exposing the adversarial image and reducing or more likely nullifying its effectiveness. If, for example, the reproduction of the adversarial image were to be the size of a foulard (e.g. 90×90 cm), it would be too large to be shown in its entirety. As the skilled person can well understand, in order to be shown in its entirety, the adversarial image reproduced on the knitting fabric must be of a size such that it can be contained in the front panel of a piece of clothing, e.g. a T-shirt or sweatshirt, but also a mask or cap. The maximum acceptable size for an adversarial image to be reproduced on a knitted fabric therefore depends on the type and size of the piece of clothing on which it is to be reproduced. Typically, the front panel of a men's T-shirt size XL has a width of 62 cm, while the minimum thigh width of trousers is approximately 22 cm. Therefore, for the purposes of the present invention, the maximum acceptable size for the adversarial image reproduced on the knitted fabric is less than 62 cm, preferably less than 50 cm.

In addition to the maximum size, a minimum size should also be considered, below which the adversarial image loses its effectiveness. This minimum size can be identified as approximately 15 cm.

At this stage of the method it is necessary to define the gauge of the machine that will be used, because the gauge links the image size expressed in number of stitches to the size expressed in centimetres. As already mentioned above, in a common machine with gauge 12, since one inch of the needle bed comprises 12 needles, a stitch has an initial width of approximately 2 mm, measured near the needle bed while the knitted fabric is being produced. When the fabric is removed from the machine, its natural elasticity spontaneously reduces its width by 10-20%. It is inferred that the maximum acceptable size for the adversarial image reproduced on the knitted fabric may not exceed 375 stitches for a machine with gauge 12. If a machine with higher gauge is used, the maximum acceptable size for the adversarial image reproduced on the knitted fabric could increase, e.g. if the gauge is double (gauge 24) the maximum acceptable size for the adversarial image may also be doubled, thus reaching 750 stitches.

From these considerations a rule of thumb can be derived according to which the ratio between the maximum acceptable size of the adversarial image in stitches and the gauge of the machine is constant and, in particular, it is equal to 31.25. From this rule of thumb it is therefore possible to obtain the maximum acceptable size of the adversarial image in stitches for machine gauges other than those considered above. For example, for a gauge 7, based on the rule of thumb defined above, the maximum acceptable size of the adversarial image would be approximately 218 stitches.

Another limit that needs to be considered at this stage is the one imposed by the total number of needles in the needle bed of the machine itself. Some machines in fact have a needle bed comprising 500 needles while others reach up to 900 needles. This number naturally represents an upper limit that cannot be exceeded in any way by the width of the adversarial image measured in stitches.

In the context of the method in accordance with the invention, it is therefore necessary to modify the adversarial image from the original (a priori unknown) size to the desired size, while maintaining the original proportions. As mentioned above, the maximum size of the adversarial image is set to a number P of pixels, where P≤750, and the minimum size is set to a number p of pixels, where p≥100 (block 103). In most cases this operation implies a reduction in the size of the known adversarial image. In fact, known adversarial images are usually intended to be printed on an A4 sheet. Since it must be printed with a resolution of at least 300 dpi in order not to lose its effectiveness, a known adversarial image can usually be considered to have a size of about 2480×3508 pixels.

The case of a truly effective adversarial image having a maximum size of less than 750 pixels is quite rare. Indeed, the effectiveness of an adversarial image usually requires a high definition and therefore a high number of pixels. Even rarer is the case where this size has to be increased, since, in the context of the method of the invention, sizes close to or equal to 750 pixels are only necessary to obtain the largest possible images (about 62 cm) using a machine with gauge 24. Both of these occurrences are in turn quite rare. Therefore, although it is extremely rare, the case where an increase in the image size (rather than a reduction thereof) is necessary must still be considered here. Common digital image processing and editing programs have no problem increasing the pixel size of an image, which is why this case can also be handled easily in the context of this method.

With regard to the lower limit for the number p of pixels of the minimum size, studies carried out by the Applicant have shown that 100 is the minimum value that allows, under certain conditions that will be explained in more detail below, the effectiveness of the adversarial image to be maintained. Of course, even for this lower limit, some consideration should be given to the gauge of the machine. The lower limit of 100 pixels was determined using gauge 12. As the skilled person can well consider, by using a higher gauge the size in centimetres of the adversarial image are reduced. For example, using a gauge 24 the size in centimetres of the adversarial image would be halved compared to that obtained with gauge 12, making it an ineffective image. For this reason it is preferable that, when using a gauge 24, the lower limit is raised to approximately 180 stitches.

By way of example, considering a typical adversarial image in square format, the size of 250×250 pixels with gauge 12 can be considered.

Once the adversarial image has been reduced to the size that, in pixels, reproduces the desired size in stitches, the proportions of the adversarial image must be altered to take account of the fact that the stitches are twice as high as the width. For this reason, if the original proportions were maintained, the image reproduced on the knitted fabric would be doubled in height. The method of the invention therefore provides for keeping the previously defined width W for the adversarial image fixed (keeping it at 250 pixels, for example) and for halving its height H (reducing it to 125 pixels, for example) (block 104).

Similarly to what has been described above in relation to sizes, the adversarial image must also be simplified in relation to the number of colors used. Known adversarial images are usually characterised by a high number of colors, typically they are available in the common 24-bit JPEG format which allows up to 16.7 million colors to be used. As already mentioned, knitting machines usually allow using up to 8 colors, which are also obtained by using the yarn commonly used as waste yarn. The tests carried out by the Applicant have in fact shown that instead of the waste yarn, a common working yarn can be provided which is retained in the finished fabric. In this way, of course, the initial section of the knitted fabric is made with a working yarn. The initial section of the knitted fabric must be stabilised or removed from the finished product, in a per se known manner.

The method of the invention therefore requires to drastically reduce the number of colors up to a number C, less than or equal to Y, i.e. included within the maximum number of yarns that can be used by the machine. In addition to the upper limit Y, which is defined by the structure of the machine initially provided, there is also a lower limit for the number C. The studies carried out by the Applicant have in fact shown that the effectiveness of an adversarial image increases as the number of colors increases and that effectiveness is lost by using fewer than 4 colors. In practice, therefore, the number C of colors must satisfy the relation 4≤C≤Y, where Y is usually equal to 8.

The operation of reducing the number of colors is commonly known in the digital image processing industry as posterization. Posterization requires that the number C of prevalent colors be identified and that, for each pixel of the image, the original color is replaced with the closest color among the C colors identified (block 105).

Preferably after the posterizing step, the method of the invention comprises a step of encoding the adversarial image using a technique known as indexed color. When an image is encoded with this technique, which is per se widely known in the field of digital image management, the color information is no longer reported in the individual pixel data, but are stored in a separate table called the color lookup table (CLUT).

The image obtained at this point in the method has a number of colors that can be obtained through as many yarns and a number of pixels that can be converted directly into stitches. This image can then be treated as a common pattern by the programmable electronic Jacquard knitting machine. In particular, the machine itself can process the image to derive its own work file containing the instructions to make the electromechanical parts operate correctly to reproduce the adversarial image on the front of the knitted fabric (block 106).

At this point in the method, a number C of yarns each having a different prevalent color must be selected such that the prevalent colors of the yarns best approximate the colors required for the posterized adversarial image (block 107).

Ideally, in order to carry out this operation it is possible, for each of the C colors required (target colors), to search in a catalogue for the yarn with the most similar color among all the available yarns (available colors). Alternatively or additionally, a different process for approximating the target color is also possible. Since each yarn can be made up of more than one thread, provided the correct count is obtained, it is also possible to choose a plurality of threads of different colors, such that the prevalent color (intuitively the average of all the colors of the threads present) approximates the target color. According to studies carried out by the Applicant, this effect (called melange) is a factor that improves the effectiveness of the reproduced adversarial image.

The steps described above involve processing colors. For example, it is required to compare each target color, defined during the posterization step, with a series of colors available in a catalogue of yarns. Again, the identification of a prevalent color (or average of colors) in a yarn consisting of a plurality of threads of different colors is required. This processings can be done automatically using common colorimetric techniques, which are widely known in the industrial field. In particular, the color definition of the posterized adversarial image, generally formulated according to the RGB (Red Green Blue) color model, can be converted in a per se known manner into a corresponding definition according to other color models, such as the CMY (Cyan Magenta Yellow) model or the CMYK (Cyan Magenta Yellow blacK) model which are commonly used for printing, and again into a color according to the Panton® standard which is commonly adopted for many industrial products. Such conversions do not always guarantee absolute color fidelity, but for the purposes of the present invention the approximations commonly introduced in the conversions are largely acceptable.

Each color model (RGB, CMY, CMYK) defines a color space within which the colors are identified by coordinates and in which it is therefore possible to process colors numerically. For example, given a target color (one of the colors of the posterized adversarial image), and a plurality of available colors (the colors of various threads available in the catalogue), it is possible to identify which of the available colors best approximates the target color, i.e. which one is the closest to it in space. Again, in a suitable color space, it is possible to calculate the average between several different colors to define the prevalent color of a yarn made up of a plurality of threads of different colors. Finally, by combining the two operations described above, it is possible to define which combination of available threads generates a prevalent color that best approximates a specific target color. This last operation allows the technique that uses the melange effect to be adopted and optimised.

Once the yarns and/or groups of threads that best approximate each of the target colors of the posterized adversarial image have been identified from the catalogue, the yarns and/or threads must be correctly loaded onto the machine and correctly fed to the respective yarn guides (block 108). This operation, per se widely known to technicians working with knitting machines, is usually facilitated by the machine itself, which provides the operator with the possibility of matching each color to a specific yarn guide and therefore of correctly positioning the yarns in the correct sequence.

When all the operations described above have been carried out correctly, the Jacquard knitting machine can be operated to manufacture the knitted fabric reproducing the adversarial image (block 109).

As described above, the adversarial image is reproduced on the front of the knitted fabric, where each stitch is used as one pixel of the adversarial image. As far as the back side of the knitted fabric is concerned, in a per se known manner it is possible to choose different structures according to which all the yarns which are present in the fabric and which are not used on the front can be arranged. For the back side of the knitted fabric, it is preferable to adopt the structure known as twill, as this allows the size of the fabric, and therefore of the adversarial image on the front, to be maintained more closely. In addition, the twill structure, by advantageously using appropriate yarn tensions, prevents the yarns present on the back side of the fabric from showing through to the front, altering the adversarial image.

Within the context described above in its general form, the method of the invention can take various embodiments. A specific embodiment of the method is described below in detail:
providing a computer on which an image processing program is executed;
obtaining a known adversarial image in square format;
opening the known adversarial image in the image processing program;
selecting the function for modifying the image size;
maintaining the proportions between height and width of the image;
imposing the number P of pixels=300 pixels;
setting the resolution to 72 dpi;
saving the image in .psd format;
separating height from width;
halving the height;
posterizing the image by choosing the number C of colors to be obtained, with C=8;
transforming the image into an indexed color image;
saving the adversarial image in .tiff format;
providing a programmable electronic Jacquard knitting machine;
selecting the machine gauge 12;
importing the adversarial image in .tiff format;
positioning the adversarial image in the work area;
selecting the work area surrounding the adversarial image and assigning it one of the C colors of the adversarial image;
choosing the twill structure for the back side of the fabric;
selecting the adversarial image;
generating the instructions for the machine;
assigning each color to a respective yarn guide;
selecting C yarns each having a prevalent color, such that each of the colors in the adversarial image is best approximated by one of the yarns;
placing the yarns in their respective yarn guides;
operating the machine.

In light of all that has been described above, it is clear to the skilled person that there are many variables to be defined in order to carry out the method. The results obtained by the Applicant thanks to the studies carried out are reported below.

The most important variables are undoubtedly the stitch size of the image and the number of colors used. For example, an adversarial image of satisfactory effectiveness can be obtained:
with minimum size of at least 100 stitches, provided that at least 8 colors are used (i.e. p≥100 if C≥8);
with minimum size of at least 200 stitches, provided that at least 7 colors are used (i.e. p≥200 if C≥7); and
with minimum size of at least 250 stitches, provided that at least 4 colors are used (i.e. p≥250 if C≥4).

The combinations shown above represent the lower limit of effectiveness: other combinations, in which the dimensions are decreased for the same colors and/or in which the colors are decreased for the same size, result in ineffective adversarial images. Conversely, other combinations in which the size and/or number of colors are increased result in more effective adversarial images.

The maximum number of stitches that can be used depends on two factors: the gauge of the machine and the maximum final size of the images. The most common machines, including the machines used in the Applicant's studies, have gauge 12. In this case, the maximum size of the images may not exceed 375 stitches in width and 62 centimetres in width. Greater widths do not allow for full exposure of the adversarial image, which has to be folded or wrapped, losing its effectiveness.

If a greater gauge is available, the size of the images in stitches may be increased, as long as the same upper limit is maintained for the size in centimetres.

Another parameter affecting the effectiveness of the final adversarial image obtained is the way in which the prevalent color of each yarn is obtained. In general, other parameters being equal, an adversarial image in which the melange effect is used is more effective than the same image in which the colors are uniform inside. In other words, the final effectiveness of the adversarial image can be increased by using a plurality of threads (e.g. 3) to make up each yarn, using threads of slightly different colors in which the prevalent color (or the average of the colors) approximates the target color defined by the posterization.

A further parameter influencing the effectiveness of the final adversarial image obtained is the material of which the yarns are made. In general, other parameters being equal, the Applicant noted that glossy materials lead to greater effectiveness than opaque materials. For this reason, cotton, polyester, viscose, rayon, acetate, bemberg, lurex and silk yarns are more effective than wool, hemp and linen yarns. In this regard, it should be noted that the effectiveness of the yarns can be increased through some treatments which, in a per se known way, enhance their lustre. For example, mercerization enhances the lustre of yarns by increasing their effectiveness in the method of the invention.

As the skilled person may well understand, the invention overcomes the drawbacks highlighted above in relation to the prior art.

In particular, the invention makes available a method for manufacturing a knitted fabric that reproduces an effective adversarial image.

Moreover, all the details can be replaced by other technically equivalent elements.

In practice, the materials used, as well as the contingent shapes and sizes, can be whatever according to the requirements without for this reason departing from the scope of protection of the following claims.

1-7. (canceled)

8. A method for manufacturing a Jacquard knitted fabric, comprising the steps of:
providing an electronic processing unit configured for modifying digital images;
providing a programmable electronic Jacquard knitting machine, configured for managing Y yarns, including the waste yarn;
obtaining a known digital adversarial image having more than 256 colors;
modifying a size of the adversarial image such that:
original proportions are maintained;
a maximum size between height and width is set to P pixels, with P≤750;
a minimum size between height and width is set to p pixels, with p≥100;
modifying the size of the adversarial image such that:
a number of pixels of the height is halved with respect to the previous step;
a number of pixels of the width is maintained the same with respect to the previous step;
posterizing the adversarial image reducing the number of colors to C, where 4≤C≤Y;
generating operation instructions for the programmable electronic Jacquard knitting machine, wherein:
each color of the adversarial image corresponds to a respective yarn; and
each pixel of the adversarial image corresponds to one stitch visible on the front of the knitted fabric;
selecting C yarns each having a different prevalent color, such that the prevalent colors of the yarns best approximate the colors of the posterized adversarial image;
feeding the C yarns to the Jacquard knitting machine; and
operating the Jacquard knitting machine for manufacturing a knitted fabric reproducing the adversarial image.

9. The method according to claim 8, wherein:
if the programmable electronic Jacquard knitting machine defines gauge 12, then p≥100 and P≤375; and
if the programmable electronic Jacquard knitting machine defines gauge 24, then p≥180 and P≤750.

10. The method according to claim 9, wherein the programmable electronic Jacquard knitting machine defines gauge 12 and wherein the adversarial image has:
a minimum size of at least 100 stitches, if at least 8 colors are used (p≥100 if C≥8);
a minimum size of at least 200 stitches, if at least 7 colors are used (p≥200 if C≥7); or
a minimum size of at least 250 stitches, if at least 4 colors are used (p≥250 if C≥4).

11. The method according to claim 8, wherein one or more of the C yarns is made of a plurality of different threads.

12. The method according to claim 11, wherein at least one of the target colors defined during the posterization step is approximated by an average of all the colors of the threads in a yarn.

13. The method according to claim 8, wherein a twill structure is adopted for a back side of the knitted fabric.

14. for the back side of the knitted fabric according to claim 8, wherein the yarns are cotton, polyester, viscose, rayon, acetate, bemberg, lurex, and/or silk yarns.
